(19) United States
(12) Patent Application Publication
(10) Pub. No.: US 2023/0340217 A1
(43) Pub. Date: Oct. 26, 2023

(54) METHOD FOR PRODUCING STRETCHED FILM

(71) Applicant: KANEKA CORPORATION, Osaka (JP)

(72) Inventors: Akira Kikuzawa, Osaka (JP); Teigo Okoshi, Osaka (JP)

(73) Assignee: KANEKA CORPORATION, Osaka (JP)

(21) Appl. No.: 18/217,760

(22) Filed: Jul. 3, 2023

Related U.S. Application Data
(63) Continuation-in-part of application No. PCT/JP2021/048687, filed on Dec. 27, 2021.

(30) Foreign Application Priority Data
Jan. 4, 2021 (JP) 2021-000276

(51) Int. Cl. C08J 5/18; C08J 3/12; G02B 1/08

(52) U.S. Cl. CPC C08J 5/18; C08J 3/126; G02B 1/08; C08J 2333/08

(57) ABSTRACT

A stretched film is produced by stretching a resin film at a given temperature. The resin film contains an acrylic resin having a glass transition temperature (Tg) of 115° C. or higher and acrylic rubber particles. The total amount of an acrylic ester monomer as a constituent monomer of the acrylic rubber particles is from 10 to 40 wt % based on the total amount of constituent monomers of the acrylic resin and the acrylic rubber particles. The stretching temperature is from Tg+20° C. to Tg+70° C.

### CROSS-REFERENCE TO RELATED APPLICATIONS

The present application is a bypass continuation of PCT Filing PCT/JP 2021-048687, filed Dec. 27, 2021, which claims priority to JP 2021-000276, filed Jan. 4, 2021, both of which are incorporated by reference in their entirety.

### BACKGROUND

### 1. Technical Field

One or more embodiments of the present invention relate to a method for producing a stretched film usable as an optical film or the like, to a polarizer protective film, and to a polarizing plate.

### 2. Description of the Related Art

In recent years, optical films made of acrylic resin have been used as polarizer protective films to achieve improved moisture resistance and water absorbency. However, optical films made of acrylic resin have low bond performance to polarizers and could thus cause degraded polarizing plate properties such as color disturbance and color unevenness which arise from warping or deformation. To address the above, studies aimed at bond performance improvement have been conducted.

For example, Japanese Laid-Open Patent Application Publication No. 2010-231015 is directed to a film containing an acrylic resin and acrylic rubber particles and proposes a method in which the number-average particle size of rubber portions of the acrylic rubber particles is set within a given range.

WO 2018/168960 proposes a method for producing a stretched film excellent in heat resistance, dimensional stability, mechanical properties, and bond performance by stretching a resin film in a given temperature range, the resin film containing an acrylic resin having a glass transition temperature of 120° C. or higher and acrylic rubber particles.

As described in WO 2018/168960, blending an acrylic resin with acrylic rubber particles and stretching a film made of the blend can result in an acrylic resin film with improved mechanical properties and bond performance.

However, in WO 2018/168960, the bond performance of the acrylic resin film is evaluated in a way where an easily-bondable layer containing a urethane resin and a crosslinking agent is disposed on the film and then the film with the easily-bondable layer is attached to a base material by means of an adhesive (paragraphs 0156 and 0157). This means that in order for an acrylic resin film to achieve satisfactory bond strength, an easily-bondable layer serving as a primer needs to be interposed between the film and a layer of an adhesive.

An aspect of one or more embodiments of the present invention is to provide a method for producing a stretched film excellent in mechanical properties and able to exhibit high bond strength without the help of any easily-bondable layer.

Another aspect of one or more embodiments of the present invention is to provide: a polarizer protective film excellent in mechanical properties and able to exhibit satisfactory bond strength to a polarizer without the help of any easily-bondable layer; and a polarizing plate including the protective film.

The present inventors have found that the above can be solved by stretching a resin film at a given temperature when the resin film is one which contains an acrylic resin and acrylic rubber particles and in which the amount of an acrylic ester monomer as a constituent monomer of the acrylic rubber particles is controlled within a given range. Based on this finding, the inventors have completed one or more embodiments of the present invention.

### SUMMARY

Specifically, one or more embodiments of the present invention relate to a method for producing a stretched film, the method including stretching a resin film at a given temperature, wherein the resin film contains an acrylic resin having a glass transition temperature (Tg) of 115° C. or higher and acrylic rubber particles, a total amount of an acrylic ester monomer as a constituent monomer of the acrylic rubber particles is from 10 to 40 wt % based on a total amount of constituent monomers of the acrylic resin and the acrylic rubber particles, and the given temperature is from Tg+20° C. to Tg+70° C.

Preferably, an amount of the acrylic ester monomer in the constituent monomers of the acrylic rubber particles is from 45 to 90 wt %.

Preferably, a proportion of the acrylic rubber particles in a total amount of the acrylic resin and the acrylic rubber particles is from 15 to 50 wt %.

Preferably, the acrylic ester monomer has the following structure.

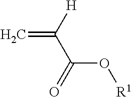

In the formula, R¹ is a linear or branched alkyl group having 1 to 10 carbon atoms.

Preferably, the acrylic rubber particles are core-shell elastic particles each of which includes a soft core layer and a rigid shell layer, the core layer is formed from a monomer component (a) containing a polyfunctional monomer (a1) having two or more polymerizable functional groups per molecule and a monomer (a2) other than the polyfunctional monomer, and the monomer (a2) other than the polyfunctional monomer contains 40 to 100 wt % of an acrylic ester monomer.

Preferably, the shell layer is formed from a monomer component (b) containing 1 to 50 wt % of an acrylic ester monomer.

Preferably, an amount of the polyfunctional monomer (a1) is from 0.5 to 3.0 parts by weight per 100 parts by weight of the monomer (a2) other than the polyfunctional monomer.

Preferably, an average particle size of the core layers is from 25 to 300 nm.

Preferably, the number of MIT double folds, as measured for the stretched film, is 150 or more.

Preferably, a 90° peel strength, as measured at 23° C. and 55% RH for the stretched film attached to a PET film via an active energy ray-curable adhesive, is 1.0 N/20 mm or more.

One or more embodiments of the present invention also relate to a polarizer protective film containing: an acrylic resin having a Tg of 115° C. or higher; and acrylic rubber particles, wherein

a total amount of an acrylic ester monomer as a constituent monomer of the acrylic rubber particles is from 10 to 40 wt % based on a total amount of constituent monomers of the acrylic resin and the acrylic rubber particles,

an amount of the acrylic ester monomer in the constituent monomers of the acrylic rubber particles is from 45 to 90 wt %, and

a 90° peel strength, as measured at 23° C. and 55% RH for the polarizer protective film attached to a PET film via an active energy ray-curable adhesive, is 1.0 N/20 mm or more.

Preferably, the number of MIT double folds, as measured for the polarizer protective film, is 150 or more.

One or more embodiments of the present invention further relate to a polarizing plate including the polarizer protective film, an adhesive layer, and a polarizer that are stacked in this order.

Preferably, the polarizing plate does not include an easily-bondable layer.

One aspect of one or more embodiments of the present invention can provide a method for producing a stretched film excellent in mechanical properties and able to exhibit high bond strength without the help of any easily-bondable layer.

Another aspect of one or more embodiments of the present invention can provide: a polarizer protective film excellent in mechanical properties and able to exhibit satisfactory bond strength to a polarizer without the help of any easily-bondable layer; and a polarizing plate including the protective film.

### DETAILED DESCRIPTION

Hereinafter, one or more embodiments of the present invention will be described in detail. One or more embodiments of the present invention are not limited to the described one or more embodiments. One or more embodiments of the present invention are not limited to the features described below and may be modified in various ways without departing from the scope as defined by the appended claims. One or more embodiments or examples derived from any combination of technical means disclosed in different embodiments or examples are included in the technical scope of one or more embodiments of the present invention.

A method for producing a stretched film according to the present disclosure includes stretching a resin film at a given temperature. The resin film contains an acrylic resin having a glass transition temperature (Tg) of 115° C. or higher and acrylic rubber particles, and the total amount of an acrylic ester monomer as a constituent monomer of the acrylic rubber particles is from 10 to 40 wt % based on the total amount of the constituent monomers of the acrylic resin and the acrylic rubber particles. The given temperature is from Tg+20° C. to Tg+70° C.

(Acrylic Resin)

The resin film contains an acrylic resin.

The glass transition temperature (Tg) of the acrylic resin only needs to be 115° C. or higher and is not limited to a particular range. The glass transition temperature of the acrylic resin may be 117° C. or higher, 118° C. or higher, or 119° C. or higher. The glass transition temperature of the acrylic resin may be 120° C. or higher, 125° C. or higher, or 130° C. or higher. The upper limit of the glass transition temperature is not limited to a particular value, and the glass transition temperature may be 170° C. or lower or 160° C. or lower.

The glass transition temperature of the acrylic resin is a peak temperature in a DSC curve measured for the acrylic resin.

In some cases where a DSC curve is measured for a resin film containing an acrylic resin and acrylic rubber particles, two peaks may appear. The higher of the two peak temperatures can be determined as the glass transition temperature of the acrylic resin. Alternatively, the resin film may be dissolved in a suitable solvent, the resulting solution may be centrifuged to separate the acrylic resin from the acrylic rubber particles, and a DSC curve may be measured for the separated acrylic resin to determine the glass transition temperature of the acrylic resin.

The acrylic resin may be a polymer composed mainly of an alkyl methacrylate. For example, the acrylic resin may be a copolymer of 50 wt % or more of an alkyl methacrylate and 50 wt % or less of a monomer other than alkyl methacrylates or may be a homopolymer of an alkyl methacrylate. The alkyl methacrylate used is typically one whose alkyl group has 1 to 8 carbon atoms and preferably one whose alkyl group has 1 to 4 carbon atoms. In particular, methyl methacrylate, whose alkyl group has one carbon atom, may be used.

The monomer other than alkyl methacrylates may be a monofunctional monomer having one polymerizable carbon-carbon double bond per molecule or a polyfunctional monomer having two or more polymerizable carbon-carbon double bonds per molecule. A monofunctional monomer may be used herein. Specific examples of the monomer include: (meth)acrylic esters other than alkyl (meth)acrylates, such as benzyl (meth)acrylate, cyclohexyl (meth)acrylate, phenyl (meth)acrylate, dicyclopentanyl (meth)acrylate, and isobornyl (meth)acrylate; styrenic monomers such as styrene and alkyl styrenes; unsaturated nitrile monomers such as acrylonitrile and methacrylonitrile; and maleimide monomers such as N-phenylmaleimide and N-cyclohexylmaleimide.

In terms of mechanical properties, heat resistance, and transparency, the monomer composition of the acrylic resin may be such that the proportion of the alkyl methacrylate is 70 wt % or more, 80 wt %, or 90 wt % or more, based on 100 wt % of the total monomers. The proportion of the alkyl methacrylate may be 99 wt % or less.

The acrylic resin may be an acrylic resin having a ring structure in a main chain. Examples of the ring structure include at least one ring structure selected from the group consisting of a glutarimide ring, a lactone ring, maleic anhydride, maleimide, and glutaric anhydride. The presence of such a ring structure makes it possible to render the stretched film resistant to heat. Among others, a glutarimide ring structure is particularly preferred in terms of the ease and cost of production and the quality stability against moisture.

(Acrylic Resin Having Glutarimide Ring)

The acrylic resin having a glutarimide ring as the ring structure is a resin containing a glutarimide unit represented by the following formula (1) and a methyl methacrylate unit, and can be obtained by heating and melting an acrylic resin containing an acrylate unit in an amount of less than 1 wt % and by treating the molten acrylic resin with an imidization agent.

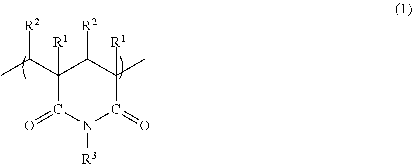

In this formula, R¹ and R² are each independently a hydrogen atom or an alkyl group having 1 to 8 carbon atoms, and R³ is an alkyl group having 1 to 18 carbon atoms, a cycloalkyl group having 3 to 12 carbon atoms, or an aryl group having 6 to 10 carbon atoms.

The glutarimide ring content in one or more embodiments of the present invention can be measured, for example, in the following way. The measurement is carried out using ¹H-NMR. The area of a peak at around 3.5 to 3.8 ppm which is attributed to the O—CH₃ protons of methyl methacrylate and the area of a peak at around 3.0 to 3.3 ppm which is attributed to the N—R³ protons of glutarimide groups are determined. The molar ratio of the glutarimide groups is determined from the peak areas, and the determined molar ratio is used to calculate the glutarimide ring content as a weight percentage.

(Acrylic Resin Having Lactone Ring)

The acrylic resin having a lactone ring as the ring structure is not limited to a particular resin and may be any thermoplastic polymer having a lactone ring structure in the molecule (a thermoplastic polymer having a lactone ring structure introduced into the molecular chain). The method for producing such a thermoplastic polymer is not limited to a particular technique. Preferably, the thermoplastic polymer is produced by obtaining a polymer (a) having a hydroxy group and an ester group in the molecular chain through polymerization (polymerization step) and then subjecting the obtained polymer (a) to a heat treatment to introduce a lactone ring structure into the polymer (lactone cyclization condensation step).

In the polymerization step, a monomer component containing an unsaturated monomer represented by the following formula (2) is polymerized to obtain a polymer having a hydroxy group and an ester group in the molecular chain.

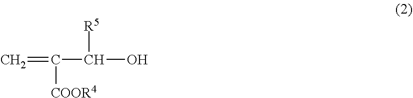

In this formula, R⁴ and R⁵ are each independently a hydrogen atom or an alkyl group having 1 to 20 carbon atoms.

Examples of the unsaturated monomer represented by the formula (2) include methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and tert-butyl 2-(hydroxymethyl)acrylate. Among these, methyl 2-(hydroxymethyl)acrylate and ethyl 2-(hydroxymethyl)acrylate are preferred. In terms of high effectiveness in improving the heat resistance, methyl 2-(hydroxymethyl)acrylate is particularly preferred. One of these unsaturated monomers may be used alone, or two or more thereof may be used in combination.

(Acrylic Rubber Particles)

The resin film contains acrylic rubber particles.

In the acrylic rubber particles, the total amount of an acrylic ester monomer may be from 45 to 90 wt % based on the total amount of the constituent monomers of the particles. In terms of mechanical strength and heat resistance, the total amount of the acrylic ester monomer may be from 48 to 85 wt %, from 50 to 80 wt %, or from 55 to 75 wt %.

The acrylic ester monomer is not limited to a particular acrylic ester, but it is preferable for the acrylic ester monomer to have the following structure in terms of mechanical strength.

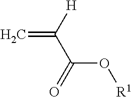

In the formula, R¹ is a linear or branched alkyl group having 1 to 10 carbon atoms.

Specific examples of the acrylic ester monomer include methyl acrylate, ethyl acrylate, propyl acrylate, butyl acrylate, hexyl acrylate, octyl acrylate, 2-ethylhexyl acrylate, and isononyl acrylate. Preferred are butyl acrylate, 2-ethylhexyl acrylate, and isononyl acrylate, among which butyl acrylate is particularly preferred in terms of mechanical strength and bond performance One of the monomers as mentioned above may be used alone, or two or more thereof may be used in combination.

The acrylic rubber particles may be core-shell elastic particles each of which includes a soft core layer and a rigid shell layer.

The Tg of the core layer may be 20° C. or lower, from −60 to 20° C., or from −60 to 10° C. When the Tg of the core layer is 20° C. or lower, the resulting stretched film can have high mechanical strength.

The Tg of the shell layer may be 50° C. or higher, from 50 to 140° C., or from 60 to 130° C. When the Tg of the shell layer is 50° C. or higher, the resulting stretched film can have high heat resistance.

The core layer is a layer formed from a monomer component (a) containing a polyfunctional monomer (a1) having two or more polymerizable functional groups per molecule and a monomer (a2) other than the polyfunctional monomer.

The proportion of the core layers in the acrylic rubber particles may be from 30 to 95 wt %, from 50 to 90 wt %, from 60 to 85 wt %, or from 60 to 80 wt %. The proportion of the shell layers in the acrylic rubber particles may be from 5 to 70 wt %, from 10 to 50 wt %, from 15 to 40 wt %, or from 20 to 40 wt %. The acrylic rubber particles may contain any other suitable component to the extent that the other component does not diminish the effect of the invention.

Any suitable polymerizable monomer may be used as the monomer (a2) other than the polyfunctional monomer. It is preferable to use at least an acrylic ester monomer. The amount of the acrylic ester monomer in the monomer component (a2) for forming the core layer may be from 40 to 100 wt %, from 50 to 100 wt %, from 60 to 100 wt %, or from 70 to 100 wt %. The amount of the acrylic ester monomer may be at most 95 wt % or at most 90 wt %.

The core layer contains the polyfunctional monomer (a1) having two or more polymerizable functional groups per molecule. The amount of the polyfunctional monomer (a1) may be from 0.5 to 3.0 parts by weight, from 0.7 to 2.5 parts by weight, from 0.8 to 2.2 parts by weight, or from 1.0 to 2.0 parts by weight per 100 parts by weight of the monomer (a2) other than the polyfunctional monomer.

Examples of the polyfunctional monomer (a1) include: aromatic divinyl monomers such as divinylbenzene; alkane polyol poly(meth)acrylates such as ethylene di(meth)acrylate, butylene di(meth)acrylate, hexylene di(meth)acrylate, oligoethylene di(meth)acrylate, trimethylolpropane di(meth)acrylate, and trimethylolpropane tri(meth)acrylate; urethane di(meth)acrylate; and epoxy di(meth)acrylate. Examples of polyfunctional monomers having vinyl groups differing in reactivity include allyl (meth)acrylate, diallyl maleate, diallyl fumarate, and diallyl itaconate. Among the monomers as mentioned above, ethylene dimethacrylate, butylene dimethacrylate, and allyl methacrylate are preferred. One of the monomers as mentioned above may be used alone, or two or more there of may be used in combination.

The monomer (a2) other than the polyfunctional monomer may include another polymerizable monomer copolymerizable with the above-described acrylic ester monomer and the above-described polyfunctional monomer having two or more polymerizable functional groups per molecule. The other polymerizable monomer may be contained in an amount of 0 to 60 wt %, in an amount of 5 to 40 wt %, or in an amount of 10 to 30 wt % in the monomer component (a) for forming the core layer.

Examples of the other polymerizable monomer include: methacrylic esters whose alkyl group has 1 to 20 carbon atoms, such as methyl methacrylate, ethyl methacrylate, propyl methacrylate, butyl methacrylate, cyclohexyl methacrylate, 2-ethylhexyl methacrylate, isononyl methacrylate, lauroyl methacrylate, and stearyl methacrylate; aromatic vinyls such as styrene, vinyltoluene, and α-methylstyrene; aromatic vinylidenes; vinyl cyanides such as acrylonitrile and methacrylonitrile; vinylidene cyanides; methyl methacrylate; urethane acrylate; and urethane methacrylate. The other polymerizable monomer may be a monomer having a functional group such as an epoxy group, a carboxyl group, a hydroxy group, or an amino group. Specifically, examples of the monomer having an epoxy group include glycidyl methacrylate. Examples of the monomer having a carboxyl group include methacrylic acid, acrylic acid, maleic acid, and itaconic acid. Examples of the monomer having a hydroxy group include 2-hydroxyethyl methacrylate and 2-hydroxyethyl acrylate. Examples of the monomer having an amino group include diethylaminoethyl (meth)acrylate. One of the monomers as mentioned above may be used alone, or two or more thereof may be used in combination.

The average particle size of the core layers may be from 25 to 300 nm or from 80 to 230 nm in terms of dispersibility and ease of handling.

The shell layer is formed from a monomer component (b) containing no polyfunctional monomer. Any suitable polymerizable monomer may be used as the monomer component (b). The amount of an acrylic ester monomer in the monomer component (b) may be from 1 to 50 wt %, from 5 to 40 wt %, or from 8 to 30 wt %.

The monomer component (b) for forming the shell layer may contain at least one monomer selected from a methacrylic ester and an aromatic vinyl monomer. The at least one monomer selected from a methacrylic ester and an aromatic vinyl monomer may be contained in an amount of 50 to 99 wt %, in an amount of 60 to 95 wt %, or in an amount of 70 to 92 wt % based on 100 wt % of the monomer component (b) for forming the shell layer.

The methacrylic ester may be, for example, a methacrylic ester whose alkyl group has 1 to 4 carbon atoms, such as methyl methacrylate or ethyl methacrylate, or methyl methacrylate. One of such methacrylic esters may be used alone, or two or more thereof may be used in combination.

Examples of the aromatic vinyl monomer include styrene, vinyltoluene, and α-methylstyrene. Among these aromatic vinyl monomers, styrene is preferred. One of the aromatic vinyl monomers may be used alone, or two or more thereof may be used in combination.

The monomer component (b) for forming the shell layer may contain another polymerizable monomer copolymerizable with the acrylic ester monomer, the methacrylic ester, and the aromatic vinyl monomer which are described above. The other polymerizable monomer may be contained in an amount of 0 to 50 wt % or in an amount of 0 to 40 wt % based on 100 wt % of the monomer component (b) for forming the shell layer.

Examples of the other polymerizable monomer include: vinyl cyanides such as acrylonitrile and methacrylonitrile; vinylidene cyanides; methacrylic esters other than those mentioned above; urethane acrylate; and urethane methacrylate. The other polymerizable monomer may be a monomer having a functional group such as an epoxy group, a carboxyl group, a hydroxy group, or an amino group. Examples of the monomer having an epoxy group include glycidyl methacrylate. Examples of the monomer having a carboxyl group include methacrylic acid, acrylic acid, maleic acid, and itaconic acid. Examples of the monomer having a hydroxy group include 2-hydroxy methacrylate and 2-hydroxy acrylate. Examples of the monomer having an amino group include diethylaminoethyl methacrylate and diethylaminoethyl acrylate. One of the monomers as mentioned above may be used alone, or two or more thereof may be used in combination.

The method employed to produce the core-shell elastic particles may be any suitable method capable of producing core-shell particles.

An example of the method is one in which: the monomer component (a) for forming the core layer is subjected to suspension polymerization or emulsion polymerization to produce a suspension or an emulsion containing core layer particles; and the monomer component (b) for forming the shell layer is added to the suspension or emulsion, in which radical polymerization of the monomer component (b) is carried out to obtain core-shell elastic particles each of which has a multi-layered structure composed of the core layer whose surface is covered by the shell layer. The monomer component (a) for forming the core layer or the monomer component (b) for forming the shell layer may be polymerized in a single stage or in two or more stages with varying monomer proportions.

(Resin Film)

The resin film contains an acrylic resin having a glass transition temperature (Tg) of 115° C. or higher and acrylic rubber particles, and the total amount of an acrylic ester monomer as a constituent monomer of the acrylic rubber particles is from 10 to 40 wt % based on the total amount of the constituent monomers of the acrylic resin and the acrylic rubber particles. In terms of bond performance and heat resistance, the total amount of the acrylic ester monomer may be from 12 to 35 wt % or from 14 to 30 wt %.

The amounts of the acrylic resin and the acrylic rubber particles in the resin film are not limited to particular ranges. In terms of mechanical properties and optical properties, the proportion of the acrylic rubber particles in the total amount of the acrylic resin and the acrylic rubber particles may be from 15 to 50 wt %. In terms of bond performance, moisture permeability, and viscosity, the proportion of the acrylic rubber particles may be from 20 to 45 wt %, from 25 to 42 wt %, or from 30 to 40 wt %.

The thickness of the resin film is not limited to a particular range. The thickness of the resin film may be 500 μm or less, 300 μm or less, or 200 μm or less. The thickness of the resin film may be 10 μm or more, 30 μm or more, 50 μm or more, or 60 μm or more. The film having a thickness within the above range is advantageous in that when vacuum molding is carried out using the film, the film is resistant to rupture in a deep drawing zone. Additionally, such a film can be produced as one that has uniform optical properties and has high transparency. If the thickness of the film is beyond the above range, the film tends to be unevenly cooled after being formed and tends to have non-uniform optical properties. If the thickness of the film is below the above range, the film could be difficult to handle.

(Method for Producing Resin Film)

The following describes one embodiment of the method for producing the resin film. One or more embodiments of the present invention are not limited to the method described below, and any conventionally-known method may be used.

Specific examples include injection molding, melt extrusion molding, blown film molding, blow molding, and compression molding. The resin film can be produced also by solution casting or spin coating in which the acrylic resin and the acrylic rubber particles are dissolved or dispersed in a solvent and then the solution or dispersion is formed into a film shape.

Among the above methods, melt extrusion molding which does not require any solvent may be used. The use of melt extrusion molding can reduce the production cost and the solvent-induced impact on the global environment or working environment.

In the case where the resin film is formed by melt extrusion molding, first, a resin composition containing the acrylic resin and the acrylic rubber particles is pre-dried and then fed to an extruder, in which the resin composition is heated and melted. The molten resin composition is then fed to a die such as a T-die through a gear pump or a filter. Subsequently, the resin composition fed to the T-die is extruded as a sheet-shaped molten resin, which is cooled and solidified by means such as a cooling roll to obtain an unstretched film (also referred to as “film web”). To ensure the desired surface texture (smoothness) of the film, the film may be sandwiched between a metal roll and a flexible roll having an elastic outer cylinder made of metal.

(Stretched Film)

In the production method according to the present disclosure, a stretched film is obtained by stretching the above resin film at a stretching temperature ranging from Tg+20° C. to Tg+70° C. Thanks to such a high stretching temperature, the acrylic resin and the acrylic rubber particles can move flexibly during the stretching to create a large number of empty gaps between molecular chains. This allows an adhesive to easily infiltrate the stretched film, which thus can exhibit high bond performance.

The stretching temperature may be from Tg+25° C. to Tg+65° C., from Tg+30° C. to Tg+60° C., from Tg+35° C. to Tg+55° C., or from Tg+40° C. to Tg+50° C. The sign “Tg” as used in relation to the stretching temperature refers to the glass transition temperature of the acrylic resin.

The stretching may be uniaxial stretching or biaxial stretching. Biaxial stretching is preferred to provide good mechanical properties both in the longitudinal direction (MD direction) and in the width direction (TD direction). The biaxial stretching may be simultaneous biaxial stretching or sequential biaxial stretching. In the case of sequential biaxial stretching, the stretching temperature in the second stretching may be in the temperature range as mentioned above.

The stretching factor for the stretched film is not limited to a particular range and may be chosen as appropriate depending on factors such as mechanical strength, surface texture, and thickness accuracy of the stretched film to be produced. In general, the stretching factor may be selected in the range of 1.1 to 5 times, selected in the range of 1.3 to 4 times, or selected in the range of 1.5 to 3 times, although the preferred stretching factor depends on the stretching temperature. When the stretching factor is within the above range, the mechanical properties such as elongation, tear propagation strength, and crease-flex resistance of the film can be considerably improved.

Annealing in a stretching machine may be performed for 1 minute or more, for 3 minutes or more, or for 5 minutes, as a pre-heating process prior to the stretching. The annealing can prevent film rupture or uneven stretching.

The stretching speed may be 50 mm/min or more or 75 mm/min or more. The stretching speed may be 300 mm/min or less or 200 mm/min or less. In the case of sequential biaxial stretching, the stretching speed may be the same or different between the first stretching and the second stretching. Preferably, the stretching speed in the second stretching is equal to or higher than the stretching speed in the first stretching. In typical sequential biaxial stretching, the first stretching is performed in the longitudinal direction (MD direction), and the second stretching is performed in the width direction (TD direction).

The stretched film according to the present disclosure can exhibit improved bond strength when bonded to a PET film via an active energy ray-curable adhesive. The bond strength is such that a 90° peel strength as measured at 23° C. and 55% RH may be 1.0 N/20 mm or more, 1.5 N/20 mm or more, 2.0 N/20 mm or more, 2.5 N/20 mm or more, or 3.0 N/20 mm or more. When the peel strength is 2.0 N/20 mm or more, the stretched film exhibits high reworkability and durability after being attached to a polarizer. The peel strength can be determined by recording measurement data with the aid of Force Logger and calculating an average of measurements in a data region where the measurement data are stable.

For the stretched film according to the present disclosure, the number of MIT double folds (also referred to as “the number of folds” hereinafter) required for film breakage in an MIT folding endurance test can be increased. The number of folds may be 150 or more, 500 or more, 1000 or more, or 2000 or more, in the longitudinal direction (MD direction) of the stretched film. When the number of folds is 150 or more, the stretched film is favorable in terms of reduced risk of rupture during an elongated film production process and in terms of reworkability after attachment to a liquid crystal panel. For the stretched film, uniaxial stretching or biaxial stretching may be performed as appropriate. In general, films tend to be broken in the width direction (TD direction). As a result of stretching, the number of MIT double folds required for film breakage in an MIT folding endurance test can be increased both in the MD direction and in the TD direction.

The total light transmittance of the stretched film according to the present disclosure, as measured when the thickness of the stretched film is 50 μm, may be 85% or more, 88% or more, or 90% or more. When the total light transmittance is within the above range, the stretched film is suitable for use in applications requiring light permeability, such as in optical members, decorative applications, interior applications, and vacuum molding applications since the stretched film has high transparency.

The glass transition temperature of the stretched film according to the present disclosure may be 115° C. or higher and may be 117° C. or higher, 118° C. or higher, or 119° C. or higher. The glass transition temperature of the stretched film may be 120° C. or higher, 125° C. or higher, or 130° C. or higher. When the glass transition temperature is within the above range, the stretched film can exhibit high heat resistance. The upper limit of the glass transition temperature is not limited to a particular value, and the glass transition temperature may be 170° C. or lower or 160° C. or lower.

The average refractive index of the stretched film according to the present disclosure may be 1.48 or more. The difference in refractive index between the acrylic resin and the acrylic rubber particles may be 0.02 or less or 0.01 or less. Since the stretched film contains the acrylic rubber particles dispersed in the acrylic resin, the internal haze of the stretched film tends to decrease as the difference in refractive index between the acrylic resin and the acrylic rubber particles becomes smaller. The average refractive index can be measured using an Abbe refractometer.

The haze of the stretched film according to the present disclosure, as measured when the thickness of the stretched film is 50 μm, may be 2.0% or less, 1.5% or less, 1.3% or less, or 1.0% or less. The haze includes a haze at the inside of the film and a haze at the surface (outside) of the film, and the two types of hazes are referred to as “internal haze” and “external haze”, respectively. The internal haze of the resin film may be 1.5% or less, 1.0% or less, 0.5% or less, or 0.3% or less. When the haze and the internal haze are within the above ranges, the stretched film is suitable for use in applications requiring light permeability, such as in optical members, decorative applications, interior applications, and vacuum molding applications since the stretched film has high transparency.

The stretched film according to the present disclosure can be used as an optical film in various situations. The optical anisotropy of the stretched film may be small, especially when the stretched film is used as a polarizer protective film. In particular, it is preferable that not only the optical anisotropy in the in-plane directions (longitudinal direction and width direction) of the film but also the optical anisotropy in the thickness direction of the film be small. That is, it is preferable that the absolute values of both the in-plane retardation and the out-of-plane retardation be small. More specifically, the absolute value of the in-plane retardation may be 10 nm or less, 6 nm or less, 5 nm or less, or 3 nm or less.

The absolute value of the out-of-plane retardation may be 50 nm or less, 20 nm or less, 15 nm or less, 10 nm or less, or 5 nm or less. The film with such retardations is suitable for use as a polarizer protective film of a polarizing plate of a liquid crystal display device. If the absolute value of the in-plane retardation of the film is more than 10 nm or the absolute value of the out-of-plane retardation of the film is more than 50 nm, the film could, when used as a polarizer protective film of a polarizing plate of a liquid crystal display device, cause a reduction in image contrast of the liquid crystal display device.

The retardations are parameters calculated based on birefringence. The in-plane retardation (Re) and the out-of-plane retardation (Rth) can be calculated by the equations given below, respectively. For an ideal film with perfect optical isotropy in three-dimensional directions, both the in-plane retardation Re and the out-of-plane retardation Rth are zero.

Re=(nx−ny)×d

Rth=((nx+ny)/2−nz)×d

In the equations, nx denotes a refractive index in an X-axis direction that is an in-plane direction in which the film extends (the direction of polymer chain orientation), ny denotes a refractive index in a Y-axis direction perpendicular to the X-axis direction, and nz denotes a refractive index in a Z-axis direction that is the thickness direction of the film. The letter d denotes the thickness of the film, and nx−ny denotes the orientation birefringence. The MD direction of the film is the X-axis direction. For the stretched film, the stretching direction is the X-axis direction.

The orientation birefringence of the resin film according to the present disclosure may be from −2.6×10⁻⁴ to 2.6×10⁻⁴, from −2.1×10⁻⁴ to 2.1×10⁻⁴, from −1.7×10⁻⁴ to 1.7×10⁻⁴, from −1.6×10⁻⁴ to 1.6×10⁻⁴, from −1.5×10⁻⁴ to 1.5×10⁻⁴, from −1.0×10⁻⁴ to 1.0×10⁻⁴, from −0.5×10⁻⁴ to 0.5×10⁻⁴, or from −0.2×10⁻⁴ to 0.2×10⁻⁴. When the orientation birefringence is within the above range, birefringence does not occur during a molding process, and stable optical properties can be achieved. In this case, the resin film is very suitable as an optical film for use in a liquid crystal display or the like.

The absolute value of the photoelastic coefficient may be small. More specifically, the photoelastic coefficient may be from −6.0×10⁻¹² to 6.0×10⁻¹², from −5.0×10⁻¹² to 5.0×10⁻¹², from −4.0×10⁻¹² to 4.0×10⁻¹², from −3.0×10⁻¹² to 3.0×10⁻¹², from −2.0×10⁻¹² to 2.0×10⁻¹², or from −1.0×10⁻¹² to 1.0×10⁻¹². When a retardation film attached to a different material in a liquid crystal display device underdoes a temperature change, a stress occurs in the retardation film due to the difference in the rate of dimensional change between the materials, thus causing a change in retardation which affects the displayed image of the display. Thus, a film less influenced by the stress, i.e., a film with a small photoelastic coefficient falling within the above range is suitable as a retardation film.

(Applications)

The stretched film can be used as a polarizer protective film. In this case, a polarizing plate can be formed by attaching the stretched film to a polarizer via an active energy ray-curable adhesive.

The active energy ray-curable adhesive is a resin that cures upon irradiation with an active energy ray. Examples of the active energy ray include an ultraviolet ray, a visible ray, an electron ray, and an X-ray.

The active energy ray-curable resin may contain a curable compound that is cationically polymerizable or a curable compound that is radically polymerizable.

Examples of the curable compound that is cationically polymerizable include an compound having an epoxy group and a compound having an oxetanyl group. Examples of the curable compound that is radically polymerizable include a compound having a carbon-carbon double bond such as that in a (meth)acryloyl group or a vinyl group and a (meth)acrylamide derivative having a (meth)acrylamide group.

The bond performance can be enhanced by inserting an easily-bondable layer. The easily-bondable layer can be formed using a known technique as described, for example, in Japanese Laid-Open Patent Application Publication No. 2009-193061 or Japanese Laid-Open Patent Application Publication No. 2010-55062. A specific example of an easily-bondable material capable of forming the easily-bondable layer is an easily-bondable composition containing a carboxyl group-containing urethane or epoxy resin as a main component and further containing a crosslinking agent. Examples of the crosslinking agent include an epoxy crosslinking agent, an oxazoline crosslinking agent, and a carbodiimide crosslinking agent.

However, the stretched film according to the present disclosure can be attached to a polarizer without the help of any easily-bondable layer since the stretched film has high bond performance. The non-use of an easily-bondable layer eliminates the cost of easily-bondable layer formation and allows the stretched film to be attached to a polarizer at high productivity.

The polarizer is not limited to a particular type, and any conventionally-known polarizer can be used. An example is a polarizer obtained by incorporating iodine into a stretched polyvinyl alcohol material.

The polarizing plate can be attached to various films and used in various products. The polarizing plate is not limited to use in particular applications but is suitable for use in an image display device such as a liquid crystal display or an organic EL display.

### EXAMPLES

Hereinafter, one or more embodiments of the present invention will be specifically described using examples. One or more embodiments of the present invention are not limited to the examples presented below. In the following description, the word “part(s)” and the symbol “%” refer to “part(s) by weight” and “wt %”, respectively, unless otherwise stated. The method for testing various physical properties discussed in the examples and comparative examples are as described below.

<Test Methods>

<Production of Acrylic Resin>

(Acrylic Resin (A1))

A poly(methyl methacrylate) resin produced by bulk polymerization and having a weight-average molecular weight of 60,000 was used as the acrylic resin. The glass transition temperature of the resin was 120° C.

(Acrylic Resin (A2))

A 40-mm-diameter intermeshing co-rotating extruder (L/D=90) was used. The setting temperature of the temperature adjustment zones of the extruder was from 230 to 280° C., and the screw rotational speed was 85 rpm. A poly(methyl methacrylate) resin (Mw: 10.5×10⁴) was fed to the extruder at a rate of 42.4 kg/hr, and the resin was melted using a kneading block to fill the extruder with the resin. After that, 1.8 parts by weight of monomethylamine (manufactured by Mitsubishi Gas Chemical Company, Inc.) was injected into the resin through a nozzle. A reverse flight was placed at the end of the reaction zone to fill the reaction zone with the resin. The by-product of the reaction and excess methylamine were removed through the vent hole at which the pressure was reduced to −0.092 MPa. The resin extruded as a strand from a die located at the extruder outlet was cooled in a water bath and then formed into pellets by a pelletizer to obtain a resin (I). Next, in the 40-mm-diameter intermeshing co-rotating extruder, the temperature of the temperature adjustment zones was set to 240 to 260° C., and the screw rotational speed was set to 102 rpm. The resin (I) acquired from a hopper was fed to the extruder at a rate of 41 kg/hr, and the resin was melted using a kneading block to fill the extruder with the resin. After that, 0.56 parts by weight of dimethyl carbonate was injected into the resin through a nozzle to reduce the amount of carboxyl groups in the resin. A reverse flight was placed at the end of the reaction zone to fill the reaction zone with the resin. The by-product of the reaction and excess dimethyl carbonate were removed through the vent hole at which the pressure was reduced to −0.092 MPa. The resin extruded as a strand from a die located at the extruder outlet was cooled in a water bath and then formed into pellets by a pelletizer to obtain a (meth)acrylic resin (A2) having a glutarimide ring. For the (meth)acrylic resin (A2), the glutarimide content was 6 wt %, the glass transition temperature was 125° C., and the average refractive index was 1.50.

<Measurement of Glass Transition Temperature>

The glass transition temperature (Tg) of each sample was determined according to JIS K 7121. Specifically, the sample was analyzed using a differential scanning calorimeter (DSC 7000X, manufactured by HITACHI). In the analysis, about 5 mg of the sample was heated from 40° C. to 200° C. at a temperature rise rate of 10° C./min and then cooled to 40° C. at a temperature decrease rate of 60° C./min. The sample was heated again from 40° C. to 200° C. at a temperature rise rate of 10° C./min, and the Tg was calculated from a DSC curve obtained in the second heating.

<Production of Acrylic Rubber Particles>

(Production Example 1)

(Production of Acrylic Rubber Particles (B1))

An 8-L polymerization reactor equipped with a stirrer was charged with the following materials.

| | |
|---|---|
| Deionized water | 180 parts |
| Polyoxyethylene lauryl ether phosphate | 0.04 parts |
| Boric acid | 0.5 parts |
| Sodium carbonate | 0.05 parts |

The interior of the polymerization reactor was thoroughly purged with nitrogen gas and then heated to 80° C., and 0.01 parts of a 2% aqueous solution of sodium hydroxide and 0.107 parts of a 2% aqueous solution of potassium persulfate were placed into the reactor. Subsequently, a material mixture as shown in “Polymerization stage (II)” of Table 1 was added continuously over 230 minutes. At 60 minutes after the start of the addition of the material mixture, 0.03 parts of a 2% aqueous solution of sodium hydroxide was further added. After the end of the addition of the material mixture, 0.015 parts of a 2% aqueous solution of potassium persulfate was added, and the polymerization was allowed to proceed for 120 minutes to obtain a polymer of the stage (II). The polymerization conversion percentage was 98.5%, and the average particle size was 109 nm.

Subsequently, a material mixture as shown in “Polymerization stage (III)” of Table 1 was added continuously over 70 minutes. After the end of the addition of the material mixture, the polymerization was allowed to proceed for 60 minutes to obtain a latex. The latex was salted out and coagulated with magnesium chloride, and the resulting product was washed with water and then dried to obtain acrylic rubber particles (B1) in the form of a white powder.

### Production Examples 2 and 3

(Production of Acrylic Rubber Particles (B2) and (B3)) Acrylic rubber particles (B2) and (B3) were produced in the same manner as the acrylic rubber particles of Production Example 1, except that the types and amounts of the materials used were changed as shown in Table 1.

### Production Example 4

(Production of Acrylic Rubber Particles (B4))

| | |
|---|---|
| Deionized water | 180 parts |
| Polyoxyethylene lauryl ether phosphate | 0.003 parts |
| Boric acid | 0.5 parts |
| Sodium carbonate | 0.05 parts |
| Sodium hydroxide | 0.01 parts |

The interior of the polymerization reactor was thoroughly purged with nitrogen gas and then heated to 80° C., and 0.03 parts of potassium persulfate in the form of a 2% aqueous solution was added. Subsequently, a material mixture as shown in “Polymerization stage (I)” of Table 1 was added continuously over 81 minutes. The polymerization was continued for another 60 minutes to obtain a polymer. The polymerization conversion percentage was 89.9%.

After that, 0.03 parts of sodium hydroxide in the form of a 2% aqueous solution was added, and 0.08 parts of potassium persulfate in the form of a 2% aqueous solution was added. Subsequently, a material mixture as shown in “Polymerization stage (II)” of Table 1 was added continuously over 150 minutes. After the end of the addition of the material mixture, 0.02 parts of potassium persulfate in the form of a 2% aqueous solution was added, and the polymerization was continued for 120 minutes to obtain a polymer of the stage (II). The polymerization conversion percentage was 97.5%, and the average particle size was 221 nm.

After that, 0.02 parts of potassium persulfate in the form of a 2% aqueous solution was added, and subsequently a material mixture as shown in “Polymerization stage (III)” of Table 1 was added continuously over 70 minutes. After the end of the addition of the material mixture, the polymerization was allowed to proceed for 60 minutes to obtain a latex. The polymerization conversion percentage was 99.9%. The obtained latex was salted out and coagulated with magnesium chloride, and the resulting product was washed with water and then dried to obtain acrylic rubber particles (B4) in the form of a white powder.

TABLE 1

| | | | Production | Production | Production | Production |
|---|---|---|---|---|---|---|
| | | | Ex. 1 | Ex. 2 | Ex. 3 | Ex. 4 |
| Acrylic rubber particles | | | B1 | B2 | B3 | B4 |
| Core | Poly- | Monomer (a2) (parts) at | | | | 27 |
| layer | merization | polymerization stage (I) | | | | |
| | stage (I) | Methyl methacrylate (%) | | | | 93.2 |
| | | Butyl acrylate (%) | | | | 6 |
| | | Styrene (%) | | | | 0.8 |
| | | Allyl methacrylate (parts) | | | | 0.5 |
| | | per 100 parts by weight | | | | |
| | | of monomer (a2) at | | | | |
| | | polymerization stage (I) | | | | |
| | | n-OM (parts) per 100 parts | | | | 0.3 |
| | | by weight of monomer (a2) | | | | |
| | | at polymerization stage (I) | | | | |
| | | Emulsifier (parts) per | | | | 0.3333 |
| | | 100 parts by weight of | | | | |
| | | monomer (a2) at | | | | |
| | | polymerization stage (I) | | | | |
| | Poly- | Monomer (a2) (parts) at | 77 | 77 | 77 | 50 |
| | merization | polymerization stage (II) | | | | |
| | stage (II) | Butyl acrylate (%) | 82 | 82 | 100 | 82 |
| | | Styrene (%) | 18 | 18 | 0 | 18 |
| | | Allyl methacrylate (parts) | 1.5 | 1.5 | 1.5 | 1.5 |
| | | per 100 parts by weight | | | | |
| | | of monomer (a2) at | | | | |
| | | polymerization stage (II) | | | | |
| | | Emulsifier (parts ) per | 0.359 | 0.359 | 0.359 | 0.4 |
| | | 100 parts by weight of | | | | |
| | | monomer (a2) at | | | | |
| | | polymerization stage (II) | | | | |
| Average particle size (nm) at end | | | 109 | 119 | 96 | 225 |
| of polymerization stage (II) | | | | | | |
| Shell | Poly- | Monomer component | 23 | 23 | 23 | 23 |
| layer | merization | (b) (parts) | | | | |
| | stage (III) | Methyl methacrylate (%) | 80 | 90 | 80 | 80 |
| | | Butyl acrylate (%) | 20 | 10 | 20 | 20 |

<Measurement of Average Particle Size>

The average particle sizes of the acrylic rubber particles were determined by measuring light scattering at a wavelength of 546 nm by means of U-5100 spectrophotometer manufactured by HITACHI and making calculations based on the measurement results.

<Bond Performance Measurement>

Each of the samples for bond performance evaluation was prepared as follows. First, each of the stretched films obtained in Examples or Comparative Examples was subjected to corona discharge treatment (13 V) using Corona Master (PS-1M) manufactured by Shinko Electric & Instrumentation Co., Ltd. An active energy ray-curable adhesive (N-(2-hydroxyethyl)acrylamide/4-acryloylmorpholine/phenylbis(2,4,6-trimethylbenzoyl)phosphine oxide=40/60/3 (weight ratio)) was then applied to the stretched film and uniformly spread by means of a No. 3 bar coater (wet thickness=6.87 μm). After that, an easily-bondable surface of a PET film (product name: COSMOSHINE 50A4100 manufactured by Toyobo Co., Ltd.) was placed onto the spread active energy ray-curable adhesive and bonded evenly to the stretched film by means of a rubber roller (the easily-bondable surface is a rough-textured surface and does not correspond to the easily-bondable layer described above). The resulting laminate was attached at its PET film side to a glass sheet by means of a pressure-sensitive adhesive tape. After that, the laminate attached to the glass sheet was pre-heated at 50° C. for 1 minute, then irradiated with UV (1000 mJ/cm²) by means of a UV irradiator manufactured by Eye Graphics Co., Ltd., and annealed at 80° C. for 3 minutes to obtain a sample.

The obtained sample was cut into a 2-cm-wide strip, which was attached to a stainless steel board by means of “PE cloth double-sided tape (0.23 mm×25 mm×15 m)” manufactured by Sekisui Chemical Co., Ltd. in such a manner that the stretched film faced downward and the PET film faced upward. A 90° peel strength in peeling of the PET film from the stretched film was measured at 23° C. and 55% RH and evaluated as an indicator of the bond strength.

<Measurement of Number of Folds>

Each of the stretched films obtained in Examples or Comparative Examples was cut into a 1.5-mm-wide strip, which was used as a test specimen. The measurement was performed using a MIT crease-flex tester, Model D manufactured by Toyo Seiki Seisaku-sho, Ltd. The test load was 200 g, the folding rate was 175 folds/min, the radius of curvature R of the folding clamp was 0.38 mm, and the folding angle was 135° both to the left and right. An arithmetic mean of values measured in the MD direction was determined as the number of folds.

### Example 1

A mixture of 80 parts by weight of the acrylic resin (A1) with 20 parts by weight of the acrylic rubber particles (B1) was kneaded by a 15-mm-diameter intermeshing co-rotating twin-screw extruder (L/D=45). The resin mixture was fed from a hopper to the extruder at a rate of 1.5 kg/hr. The setting temperature of the temperature adjustment zones of the extruder was 230° C., and the screw rotational speed was 120 rpm. A strand coming out of the die was cooled in a water bath and then formed into pellets by a pelletizer.

The obtained pellets were dried at 90° C. for 5 hours, after which the pellets were formed into a film using a 15-mm-diameter intermeshing co-rotating twin-screw extruder (L/D=30) equipped with a T-die at the extruder outlet. The pellets were fed from a hopper to the extruder at a rate of 1.5 kg/hr. The setting temperature of the temperature adjustment zones of the extruder was 230° C., the setting temperature of the T-die was 255° C., and the screw rotational speed was 100 rpm. A sheet-shaped molten resin extruded through the T-die located at the extruder outlet was cooled by a cooling roll adjusted to 90° C., and thus a resin film with a width of 120 mm and a thickness of 160 μm was obtained.

The obtained resin film was placed into a simultaneous biaxial stretching machine (PHH-302) manufactured by ESPEC Corporation and pre-heated in the stretching machine at 145° C. for 5 minutes, after which the resin film was subjected to 2×2 simultaneous biaxial stretching at a stretching speed of 100 mm/min to obtain a stretched film. The bond performance and the number of folds were measured by the methods as described above. The results are listed in Table 2.

### Examples 2 to 18 and Comparative Examples 1 to 14

Stretched films were made by performing the same procedures as in Example 1, except the amount of the acrylic resin, the type or amount of the acrylic rubber particles, or the stretching temperature was changed according to Table 2. The bond performance and the number of folds were measured by the methods as described above. The results are listed in Table 2.

TABLE 2

| | Acrylic resin | | | Acryric rubber particles | | Amount of | | | |
|---|---|---|---|---|---|---|---|---|---|
| | | | Amount | | Amount | acrylic ester | Stretching | Bond | |
| | | Tg | (parts by | | (parts by | monomer | temperature | performance | Number |
| | Type | (° C.) | weight) | Type | weight) | (wt %) | (° C.) | (N/20 mm) | of folds |
| Ex. 1 | A1 | 120 | 80 | B1 | 20 | 13.5 | 145 | 8.0 | 420 |
| Ex. 2 | A1 | 120 | 60 | B1 | 40 | 27.1 | 145 | 14.0 | 25960 |
| Ex. 3 | A1 | 120 | 80 | B1 | 20 | 13.5 | 160 | 10.0 | 240 |
| Ex. 4 | A1 | 120 | 70 | B1 | 30 | 20.3 | 160 | 11.0 | 1070 |
| Ex. 5 | A1 | 120 | 60 | B1 | 40 | 27.1 | 160 | 15.0 | 11600 |
| Ex. 6 | A1 | 120 | 70 | B2 | 30 | 19.6 | 145 | 1.4 | 3880 |
| Ex. 7 | A1 | 120 | 60 | B2 | 40 | 26.2 | 145 | 2.0 | 21020 |
| Ex. 8 | A1 | 120 | 80 | B2 | 20 | 13.1 | 160 | 14.0 | 160 |
| Ex. 9 | A1 | 120 | 60 | B2 | 40 | 26.2 | 160 | 16.0 | 4960 |
| Ex. 10 | A1 | 120 | 70 | B3 | 30 | 24.5 | 145 | 1.5 | 4930 |
| Ex. 11 | A1 | 120 | 70 | B3 | 30 | 24.5 | 160 | 6.0 | 1280 |
| Ex. 12 | A1 | 120 | 60 | B3 | 40 | 32.6 | 160 | 14.0 | 13380 |
| Ex. 13 | A1 | 120 | 70 | B4 | 30 | 14.2 | 145 | 2.8 | 1090 |
| Ex. 14 | A1 | 120 | 70 | B4 | 30 | 14.2 | 160 | 3.5 | 550 |
| Ex. 15 | A2 | 124 | 60 | B1 | 40 | 27.1 | 145 | 12.0 | 24420 |
| Ex. 16 | A2 | 124 | 80 | B1 | 20 | 13.5 | 160 | 9.0 | 220 |
| Ex. 17 | A2 | 124 | 70 | B1 | 30 | 20.3 | 160 | 10.0 | 1100 |
| Ex. 18 | A2 | 124 | 60 | B1 | 40 | 27.1 | 160 | 15.0 | 10900 |
| Comp. Ex. 1 | A1 | 120 | 100 | — | — | 0.0 | 145 | 1.3 | 10 |
| Comp. Ex. 2 | A1 | 120 | 100 | — | — | 0.0 | 160 | 0.9 | 0 |
| Comp. Ex. 3 | A1 | 120 | 90 | B1 | 10 | 6.8 | 130 | 0.6 | 850 |
| Comp. Ex. 4 | A1 | 120 | 90 | B1 | 10 | 6.8 | 160 | 2.0 | 20 |
| Comp. Ex. 5 | A1 | 120 | 60 | B1 | 40 | 27.1 | 130 | 0.8 | 308860 |
| Comp. Ex. 6 | A1 | 120 | 90 | B2 | 10 | 6.5 | 130 | 0.5 | 680 |
| Comp. Ex. 7 | A1 | 120 | 90 | B2 | 10 | 6.5 | 160 | 1.8 | 20 |
| Comp. Ex. 8 | A1 | 120 | 60 | B2 | 40 | 26.2 | 130 | 0.7 | 71180 |
| Comp. Ex. 9 | A1 | 120 | 70 | B3 | 30 | 24.5 | 130 | 0.5 | 6720 |
| Comp. Ex. 10 | A1 | 120 | 60 | B3 | 40 | 32.6 | 130 | 0.9 | 51340 |
| Comp. Ex. 11 | A1 | 120 | 90 | B4 | 10 | 4.7 | 130 | 1.1 | 20 |
| Comp. Ex. 12 | A1 | 120 | 90 | B4 | 10 | 4.7 | 160 | 1.4 | 20 |
| Comp. Ex. 13 | A1 | 120 | 70 | B4 | 30 | 14.2 | 130 | 0.8 | 1420 |
| Comp. Ex. 14 | A2 | 124 | 100 | — | — | — | 145 | 0.9 | 250 |

Table 2 reveals that the stretched films obtained in Examples 1 to 18 had both high bond performance and high folding endurance, while the stretched films obtained in Comparative Examples 1 to 14 lacked sufficient bond performance or folding endurance. A possible reason for good results obtained in Examples 1 to 18 is that the resin films were easily infiltrated with the adhesive in consequence of the stretching at a stretching temperature which allowed the molecular chains to move sufficiently flexibly and that the amounts of acrylic ester monomers contained in the acrylic resin and the acrylic rubber particles were appropriate.

Among the examples, Examples 2 to 5, 8, 9, 12, 15, 17, and 18 are particularly superior in bond performance, and Examples 2, 4, 5, 9, 12, 15, 17, and 18 are particularly preferred in terms of the balance between bond performance and folding endurance.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A method for producing a stretched film, the method comprising stretching a resin film at a stretching temperature,
wherein:
the resin film comprises:
an acrylic resin having a glass transition temperature Tg of 115° C. or higher; and
acrylic rubber particles,
a total amount of an acrylic ester monomer as a constituent monomer of the acrylic rubber particles is from 10 to 40 wt % based on a total amount of constituent monomers of the acrylic resin and the acrylic rubber particles, and
the stretching temperature is from Tg+20° C. to Tg+70° C.

2. The method according to claim 1, wherein an amount of the acrylic ester monomer in the constituent monomers of the acrylic rubber particles is from 45 to 90 wt %.

3. The method according to claim 1, wherein a proportion of the acrylic rubber particles in a total amount of the acrylic resin and the acrylic rubber particles is from 15 to 50 wt %.

4. The method according to claim 1, wherein the acrylic ester monomer has the following structure: 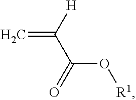
wherein R¹ is a linear or branched alkyl group having 1 to 10 carbon atoms.

5. The method according to claim 1, wherein
the acrylic rubber particles are core-shell elastic particles each of which comprises a soft core layer and a rigid shell layer,
the soft core layer is formed from a monomer component (a) comprising:
a polyfunctional monomer (a1) having two or more polymerizable functional groups per molecule; and
a monomer (a2) other than the polyfunctional monomer (a1), and
the monomer (a2) other than the polyfunctional monomer (a1) comprises 40 to 100 wt % of an acrylic ester monomer.

6. The method according to claim 5, wherein the rigid shell layer is formed from a monomer component (b) comprising 1 to 50 wt % of an acrylic ester monomer.

7. The method according to claim 5, wherein an amount of the polyfunctional monomer (a1) is from 0.5 to 3.0 parts by weight per 100 parts by weight of the monomer (a2) other than the polyfunctional monomer (a1).

8. The method according to claim 5, wherein an average particle size of the soft core layer is from 25 to 300 nm.

9. The method according to claim 1, wherein a number of MIT double folds, as measured for the stretched film, is 150 or more.

10. The method according to claim 1, wherein a 90° peel strength, as measured at 23° C. and 55% RH for the stretched film attached to a PET film via an active energy ray-curable adhesive, is 1.0 N/20 mm or more.

11. A polarizer protective film comprising:
an acrylic resin having a Tg of 115° C. or higher; and
acrylic rubber particles,
wherein:
a total amount of an acrylic ester monomer as a constituent monomer of the acrylic rubber particles is from 10 to 40 wt % based on a total amount of constituent monomers of the acrylic resin and the acrylic rubber particles,
an amount of the acrylic ester monomer in the constituent monomers of the acrylic rubber particles is from 45 to 90 wt %, and
a 90° peel strength, as measured at 23° C. and 55% RH for the polarizer protective film attached to a PET film via an active energy ray-curable adhesive, is 1.0 N/20 mm or more.

12. The polarizer protective film according to claim 11, wherein a number of MIT double folds, as measured for the polarizer protective film, is 150 or more.

13. A polarizing plate comprising:
the polarizer protective film according to claim 11,
an adhesive layer, and
a polarizer,
wherein the polarizer protective film, the adhesive layer, and the polarizer are stacked in this order.

14. The polarizing plate according to claim 13, wherein the polarizing plate does not comprise an easily-bondable layer.
